(19) United States
(12) Patent Application Publication
(10) Pub. No.: US 2021/0321369 A1
(43) Pub. Date: Oct. 14, 2021

(54) Slot Configuration and Resource Allocation for Sidelink Communication

(71) Applicant: MediaTek Singapore Pte. Ltd., Singapore (SG)

(72) Inventor: Tao Chen, Beijing (CN)

(21) Appl. No.: 17/226,831

(22) Filed: Apr. 9, 2021

Related U.S. Application Data
(63) Continuation of application No. PCT/CN2020/084193, filed on Apr. 10, 2020.

(30) Foreign Application Priority Data
Apr. 2, 2021 (CN) CN202110360115.1

(51) Int. Cl. H04W 72/02; H04W 72/04; H04L 5/14; H04L 27/26; H04W 76/27

(52) U.S. Cl. CPC H04W 72/02; H04W 72/0446; H04W 92/18; H04L 27/26025; H04W 76/27; H04L 5/1469

(57) ABSTRACT

Apparatus and methods are provided for sidelink slot configuration and resource allocation. In one novel aspect, the sidelink slot configuration is determined based on a reference numerology. In one embodiment, the UE obtains SL configuration and a TDD UL/DL configuration, determines a SL slot configuration for the SL based on the SL configuration, the TDD UL/DL configuration and the reference numerology, and performs SL transceiving through the SL based on the determined SL slot configuration. In one embodiment, the SL slot configuration configures a number of slots with SL-only symbols based on UL slot configuration, the reference numerology, and the sidelink numerology. In one embodiment, the UL slot configuration is obtained from TDD UL/DL configuration. The sidelink numerology is obtained through sidelink signaling, such the RRC messages. In yet another embodiment, the SL slot configuration is carried in the sidelink SSB.

### CROSS REFERENCE TO RELATED APPLICATIONS

This application is filed under 35 U.S.C. § 111(a) and is based on and hereby claims priority under 35 U.S.C. § 120 and § 365(c) from International Application No. PCT/CN/2020/084193, titled “Enhancement for SL Communication,” with an international filing date of Apr. 10, 2020. This application claims priority under 35 U.S.C. § 119 from Chinese Application Number CN 202110360115.1, titled “Enhancement for SL Communication,” filed on Apr. 2, 2021. The disclosure of each of the foregoing documents is incorporated herein by reference.

### TECHNICAL FIELD

The disclosed embodiments relate generally to wireless communication, and, more particularly, to slot configuration and resource allocation for sidelink communication.

### BACKGROUND

5G radio access technology will be a key component of the modern access network. It will address high traffic growth and increasing demand for high-bandwidth connectivity. In 3GPP New Radio (NR), sidelink continues evolving. With new functionalities supported, the sidelink (SL) offers low latency, high reliability and high throughout for device-to-device communications. NR vehicle to everything (V2X) supports sidelink measurement. The V2X sidelink communication can be supported by unicast, groupcast, and broadcast. To support efficient sidelink communication, the SL resource allocation needs to consider different configuration requirements and scenarios for the sidelink path and the Uu link path. The resource allocation including channel state information reference signal (CSI-RS) resource allocation and reporting, and bandwidth part (BWP) configuration for the sidelink communication. Further the slot configuration for SL shares common attributes with the existing Uu links. Share the configuration information for the sidelink and the Uu link provides efficiency for the system. However, the sidelink can be configured with different numerologies. The slot configuration requires additional steps.

Improvements and enhancements are required for sidelink slot configuration and sidelink resource allocation.

### SUMMARY

Apparatus and methods are provided for sidelink slot configuration and resource allocation. In one novel aspect, the sidelink slot configuration is determined based on a reference numerology. In one embodiment, the UE obtains SL configuration and a TDD UL/DL configuration, determines a SL slot configuration for the SL based on the SL configuration, the TDD UL/DL configuration and the reference numerology, and performs SL transceiving through the SL based on the determined SL slot configuration. In one embodiment, the SL slot configuration configures a number of slots based on a number of slots with UL-only symbols, the reference numerology, and the sidelink numerology. In one embodiment, the UL slot configuration is obtained from TDD UL/DL configuration. The sidelink numerology is obtained through sidelink signaling, such the RRC messages. In yet another embodiment, the SL slot configuration is carried in the S-SSB. For UL slots indication in S-SSB, a reference pattern can be defined and some of the patterns can refer to the reference pattern to derive the UL slots by taking into account the different granularity. The SL configuration is either configured or preconfigured.

In another embodiment, the CSI-RS transmission for CSI measurement is rated matched according to the presence derived from SCI field (e.g., 2^{nd} stage SCI) for CSI request and the configuration of CSI-RS resources. Additionally, CSI-RS resources can be mapped on the PSSCH resources transmitting TBs. The CSI-RS resources cannot be mapped to PSSCH transmitting 2^{nd} stage SCI and/or PSSCH carrying 1^{st} stage SCI. In another embodiment, the CSI-RS resources are punctured to reduce the complexity. The assumed CSI table should be indicated in SCI (i.e., 2^{nd} stage SCI) and/or the higher layer signaling for UE to derive the proper CSI index based on the CSI measurement.

In yet another embodiment, for resource pool allocation, a special sub-channel is configured to accommodate resources (or RBs) not multiple of or less than the sub-channel size. For such special sub-channels, it can be restricted for PSSCH transmission, or transmission of FDMed multiplexed PSSCH and PSCCH. The PSCCH, if possible, may across the symbols over all symbols in a SL slot, except for GP symbols and PSFCH symbols. multiple resource pools can be configured with the different sub-channel size. The UE may select the resource pool randomly or based on a rule if the priority levels are same for these resource pools.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary wireless network for measurement accurate sidelink CSI report with restriction procedure in accordance with embodiments of the current invention.

FIG. 2 illustrates an exemplary NR wireless system with centralized upper layers of the NR radio interface stacks in accordance with embodiments of the current invention.

FIG. 3 illustrates an exemplary top-level functional diagram for the sidelink slot configuration and resource allocation in accordance with embodiments of the current invention.

FIG. 4 illustrates exemplary diagrams for the sidelink slot configuration with the NR frame and slot structure in accordance with embodiments of the current invention.

FIG. 5 illustrates exemplary diagrams for the sidelink slot configuration based on the reference numerology in accordance with embodiments of the current invention.

FIG. 6 illustrates exemplary diagrams for the sidelink CSI-RS resource allocation in accordance with embodiments of the current invention.

FIG. 7 illustrates exemplary diagrams for sidelink BWP configuration and allocation in accordance with embodiments of the current invention.

FIG. 8 illustrates an exemplary flow chart for the sidelink slot configuration procedure based on the reference numerology in accordance with embodiments of the current invention.

### DETAILED DESCRIPTION

Reference will now be made in detail to some embodiments of the invention, examples of which are illustrated in the accompanying drawings.

In an NR wireless network, the sidelink is enabled. NR vehicle to everything (V2X) supports the transmission of CSI-RS. CSI-RS is confined with physical sidelink shared channel (PSSCH) transmission and it can only be transmitted if SL CQI/RI report is enabled by higher layer signaling. The SL CQI/RI report from RX UE is enabled by SCI (i.e. Sidelink Control Information) at physical layer to help the TX UE to do link adaption. The traditional CSI report over Uu is performed at physical layer. Numerology for a frame structure defines frame/slot structure such as subcarrier spacing (SCS) and symbol length. Unlike the LTE network, the numerology in the NR network supports different types of SCS. The slot configuration for the SL communication needs to consider the numerology differences between the sidelink and the Uu link.

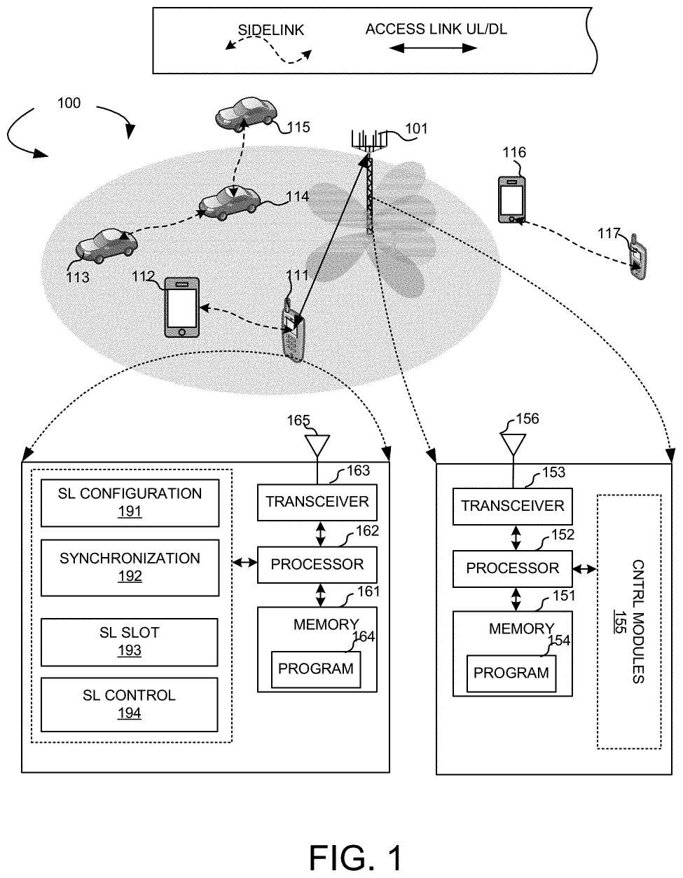

FIG. 1 is a schematic system diagram illustrating an exemplary wireless network for the sidelink slot configuration and resource allocation in accordance with embodiments of the current invention. Wireless system 100 includes one or more fixed base infrastructure units forming a network distributed over a geographical region. The base unit may also be referred to as an access point, an access terminal, a base station, a Node-B, an eNode-B (eNB), a gNB, or by other terminology used in the art. The network can be a homogeneous network or heterogeneous network, which can be deployed with the same frequency or different frequency. gNB 101 is an exemplary base station in the NR network.

Wireless network 100 also includes multiple communication devices or mobile stations, such as user equipments (UEs) 111, 112, 113, 114, 115, 116, and 117. The exemplary mobile devices in wireless network 100 have sidelink capabilities. The mobile devices can establish one or more connections with one or more base stations, such as gNB 101. UE 111 has an access link, with uplink (UL) and downlink (DL), with gNB 101. UE 112, which is also served by gNB 101, may also establish UL and DL with gNB 101. UE 111 also establishes a sidelink with UE 112. Both UE 111 and UE 112 are in-coverage devices. Mobile devices on vehicles, such as mobile devices 113, 114, and 115, also have sidelink capabilities. Mobile device 113 and mobile device 114 are covered by gNB 101. Mobile device 113, an in-coverage device, establishes sidelink with mobile device 114, which is also an in-coverage device. Mobile device 115 on a vehicle, however, is an out-of-coverage device. In-coverage mobile device 114 establishes a sidelink with the out-of-coverage device 115. In other embodiments, the mobile devices, such as UE 116 and 117, may both be out-of-coverage but can transmit and receive data packets with another one or more other mobile stations with sidelink connections.

FIG. 1 further illustrates simplified block diagrams of a base station and a mobile device/UE for the sidelink slot configuration and resource allocation. gNB 101 has an antenna 156, which transmits and receives radio signals. An RF transceiver circuit 153, coupled with the antenna, receives RF signals from antenna 156, converts them to baseband signals, and sends them to processor 152. RF transceiver 153 also converts received baseband signals from processor 152, converts them to RF signals, and sends out to antenna 156. Processor 152 processes the received baseband signals and invokes different functional modules to perform features in gNB 101. Memory 151 stores program instructions and data 154 to control the operations of gNB 101. gNB 101 also includes a set of control modules 155 that carry out functional tasks to communicate with mobile stations.

UE 111 has an antenna 165, which transmits and receives radio signals. An RF transceiver circuit 163, coupled with the antenna, receives RF signals from antenna 165, converts them to baseband signals, and sends them to processor 162. In one embodiment, the RF transceiver may comprise two RF modules (not shown). A first RF module is used for HF transmitting and receiving, and the other RF module is used for different frequency bands transmitting and receiving, which is different from the HF transceiver. RF transceiver 163 also converts received baseband signals from processor 162, converts them to RF signals, and sends out to antenna 165. Processor 162 processes the received baseband signals and invokes different functional modules to perform features in the UE 111. Memory 161 stores program instructions and data 164 to control the operations of the UE 111. Antenna 165 sends uplink transmission and receives downlink transmissions to/from antenna 156 of gNB 101.

The UE also includes a set of control modules that carry out functional tasks. These control modules can be implemented by circuits, software, firmware, or a combination of them. A sidelink (SL) configuration module 191 obtains an SL (pre-)configuration for an SL operation using an SL in a wireless network, wherein the UE is configured with a Uu link with a base station in the wireless network. A synchronization module 192 receives a time division duplex (TDD) uplink/downlink (UL/DL) configuration. An SL slot module 193 determines an SL slot configuration for the SL based on the SL (pre-) configuration, the TDD UL/DL configuration, and a reference numerology. An SL control module 194 performs SL transceiving through the SL based on the determined SL slot configuration.

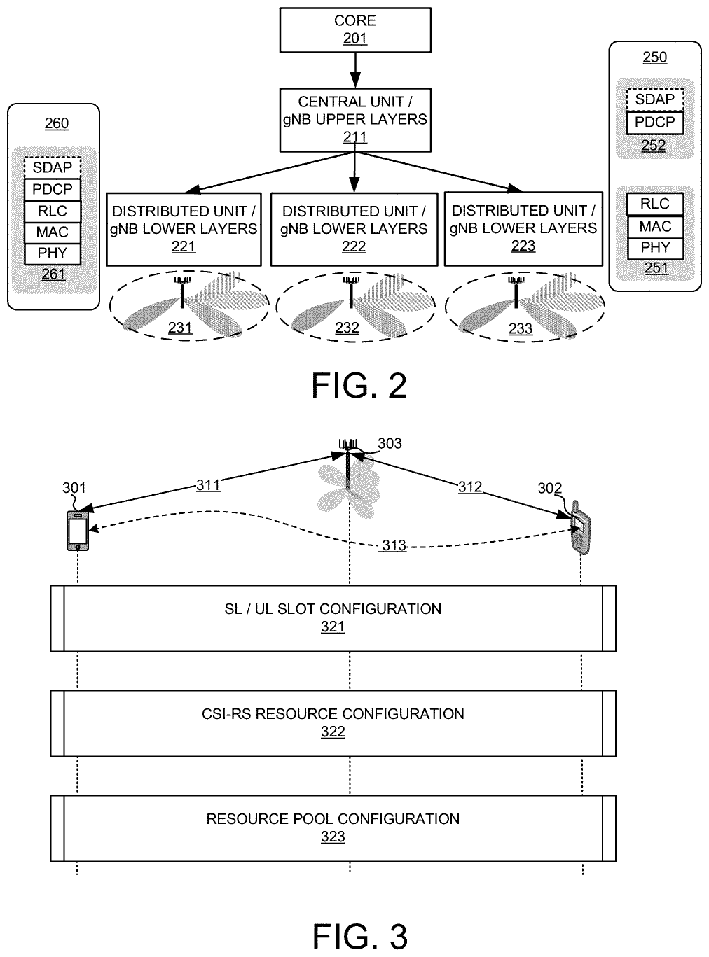

FIG. 2 illustrates an exemplary NR wireless system with centralized upper layers of the NR radio interface stacks in accordance with embodiments of the current invention. Different protocol split options between central unit (CU) and distributed unit (DU) of gNB nodes may be possible. The functional split between the CU and DU of gNB nodes may depend on the transport layer. Low performance transport between the CU and DU of gNB nodes can enable the higher protocol layers of the NR radio stacks to be supported in the CU, since the higher protocol layers have lower performance requirements on the transport layer in terms of bandwidth, delay, synchronization and jitter. In one embodiment, SDAP and PDCP layer are located in the CU, while RLC, MAC and PHY layers are located in the DU. A Core unit 201 is connected with one central unit 211 with gNB upper layer 252. In one embodiment 250, gNB upper layer 252 includes the PDCP layer and optionally the SDAP layer. Central unit 211 is connected with distributed units 221, 222, and 221. Distributed units 221, 222, and 223 each correspond to a cell 231, 232, and 233, respectively. The DUs, such as 221, 222 and 223 include gNB lower layers 251. In one embodiment, gNB lower layers 251 include the PHY, MAC and the RLC layers. In another embodiment 260, each gNB has the protocol stacks 261, including SDAP, PDCP, RLC, MAC and PHY layers.

FIG. 3 illustrates an exemplary top-level functional diagram for the sidelink slot configuration and resource allocation in accordance with embodiments of the current invention. UE 301 and UE 302 are connected with gNB 303 in the NR network through Uu links 311 and 312, respectively. In one embodiment, a sidelink 313 is configured for UE 301 and UE 302.

In one embodiment 321, the sidelink slot configuration is based on a reference numerology. UE obtains a sidelink configuration and the TDD downlink/uplink configuration. The sidelink slot configuration is derived based on the Uu link numerology and the sidelink numerology. The UE obtains a reference pattern for the slot configuration and derives SL slot pattern or UL slot pattern by taking into account the different granularity.

In another embodiment 322, CSI-RS resource allocation are performed for the sidelink communication. For CSI-RS transmission for CSI measurement, it can be rated matched according to the presence derived from sidelink control information (SCI) field (e.g., 2^{nd} stage SCI) for CSI request and the configuration of CSI-RS resources. Specifically, whether to proceed rate matching may be determined by the presence of CSI request. And how to proceed rate matching may be based on the configuration of CSI-RS resources. Additionally, CSI-RS resources can be mapped on the physical sidelink shared channel (PSSCH) resources transmitting transport blocks (TBs). In other words, it cannot be mapped to PSSCH transmitting 2^{nd} stage SCI and/or PSSCH carrying 1^{st} stage SCI. Alternatively, it can be punctured to reduce the complexity. The assumed CSI table should be indicated in SCI (e.g., 2^{nd} stage SCI) and/or the higher layer signaling for UE to derive the proper CSI index based on the CSI measurement.

In yet another embodiment 323, the resource pool configuration and allocation are performed for the sidelink communication. For resource pool allocation, a special sub-channel can be introduced for accommodating resources (or RBs) not multiple of or less than the sub-channel size. For such special sub-channels, it can be restricted for PSSCH transmission, or transmission of FDMed multiplexed PSSCH and physical sidelink control channel (PSCCH). In one embodiment, PSCCH may, if available, across the symbols over all symbols in a SL slot, except for GP symbols and physical sidelink feedback channel (PSFCH) symbols. Multiple resource pools can be configured with the different sub-channel size. The UE may select the resource pool randomly or based on a rule (e.g., priority levels for these resource pools).

In one novel aspect, the SL slot configuration is derived based on the UL slot configuration and a reference numerology. In one embodiment, the reference numerology is at least based on the UL numerology. In one embodiment, the reference numerology is the UL numerology and the number of slots with only SL symbols, the SL-only symbols, is derived based on UL-only symbols, the reference numerology, and the SL numerology

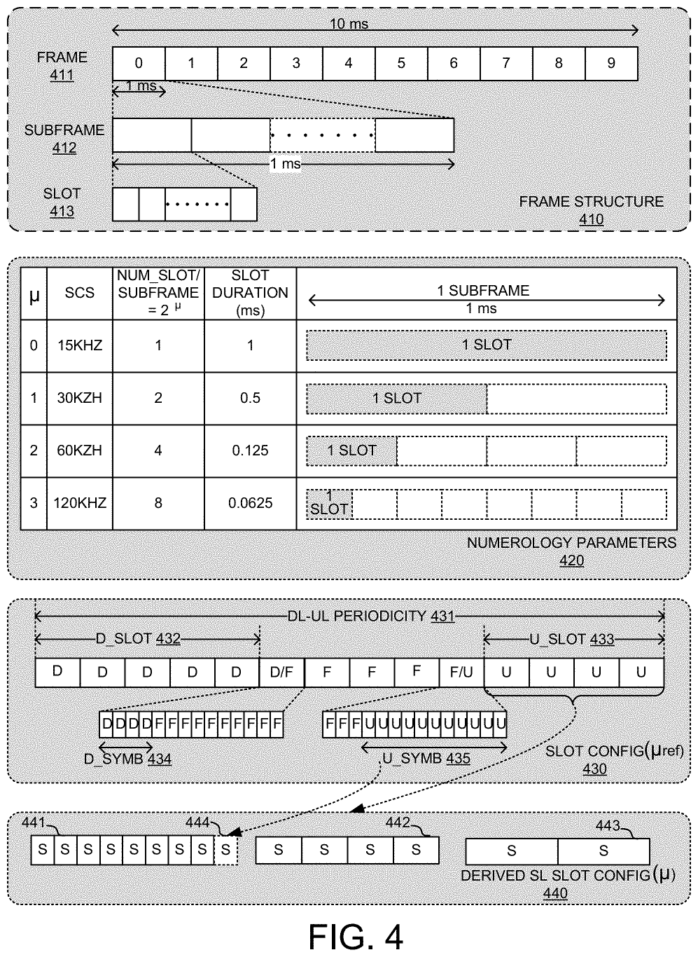

FIG. 4 illustrates exemplary diagrams for the sidelink slot configuration with the NR frame and slot structure in accordance with embodiments of the current invention. An exemplary NR frame structure 410 illustrates a frame 411, a subframe 412, and a slot 413. Frame 411 with 10 ms includes ten subframes, each with 1 ms. Subframe 412 includes one or more slots depending on the subcarrier spacing of the numerology. Each slot includes multiple symbols. Diagram 420 illustrates exemplary parameters for NR numerology. A numerology is defined by subcarrier spacing (SCS) and cyclic prefix (CP) overhead. The NR network supports multiple SCSs. Multiple SCSs can be derived by scaling a basic SCS by an integer. Diagram 420 illustrates SCS parameters for the numerology configuration. The NR network supports multiple SCSs including 15 kHz, 30 kHz, 60 kHz, 120 kHz, and more. The numerology parameter μ is an integer of {0, 1, 2, 3, . . . } each corresponds to a SCS. Each NR subframe has a length of 1 ms. The number of slots per subframe is based on the SCS and equals to 2^{μ}. The slot duration is ½^{μ} ms. In other embodiments, the NR network supports more SCSs, such as 240 kHz. Diagram 420 illustrates exemplary parameters.

In the NR network, multiple SCSs are supported for slot configuration. In the current system, a slot can be classified as downlink, uplink, or mixed uplink (UL) and downlink (DL) transmission. In time division duplex (TDD), a slot may be configured for a mixed use for UL and DL. The NR TDD uses flexible slot configuration. The configuration of slot format in the NR can be static, semi-static, and dynamic. The static and semi-static slot configuration are supported using signaling messages, such as the radio resource control (RRC) message. The dynamic configuration for slot configuration uses physical downlink control channel (PDCCH) downlink control information (DCI). The slot configuration can be carried out with RRC message, such as tdd-UL-DL-ConfigurationCommon. The slot configuration may configure one pattern only or two patterns. Diagram 430 illustrates an exemplary slot configure with only pattern1 and numerology parameter μ_{ref}. A single UL/DL pattern is repeated periodically with a dl-UL-TransmissionPeriodicity 431. The number of total slots in periodicity 431 is determined based on the periodicity and the configured SCS. The number of DL slot 432 and the number of UL slot 433 are configured within the periodicity of 431. UL slot 433 includes the slots configured for UL only. UL slots 433 are UL-only slots. The number of downlink symbols in the downlink/flexible (D/F) slot 434 and the number of uplink symbols in the flexible/uplink (F/D) slot 435 are also configured.

With the configuration parameters, the UL slots associated with a pattern as configured can be derived from the TDD UL/DL configuration. In one embodiment, the TDD UL/DL configuration is carried in SIB. When the Uu link and the sidelink has different numerologies, the number of sidelink slots is further based on the numerology differences between the SL and the Uu link. The number of uplink slots is also based on the numerology differences. Diagram 440 illustrates exemplary scenarios to derive number of sidelink slots based on numerology differences between the Uu link/interface and the sidelink. Referring to the example of diagram 430, the sidelink slot configuration uses the TDD UL/DL configuration information to derive the number of sidelink slots. In one embodiment, assume the Uu interface μ_{ref}=2. Sidelink configuration 442 has the same number of sidelink slots as the number of uplink slots. Sidelink configuration 443, with μ=1, is configured with the number of sidelink slots being a half of uplink slots. Similarly, sidelink configuration 441, with μ=3, is configured with the number of sidelink slots being twice the uplink slots. Further, when the sidelink and the Uu link has difference numerologies, the numerology differences result in additional sidelink slots based on the number of uplink symbols and the reference numerology as shown in 444. The number of the sidelink slots in the sidelink slot configuration is based on the reference numerology.

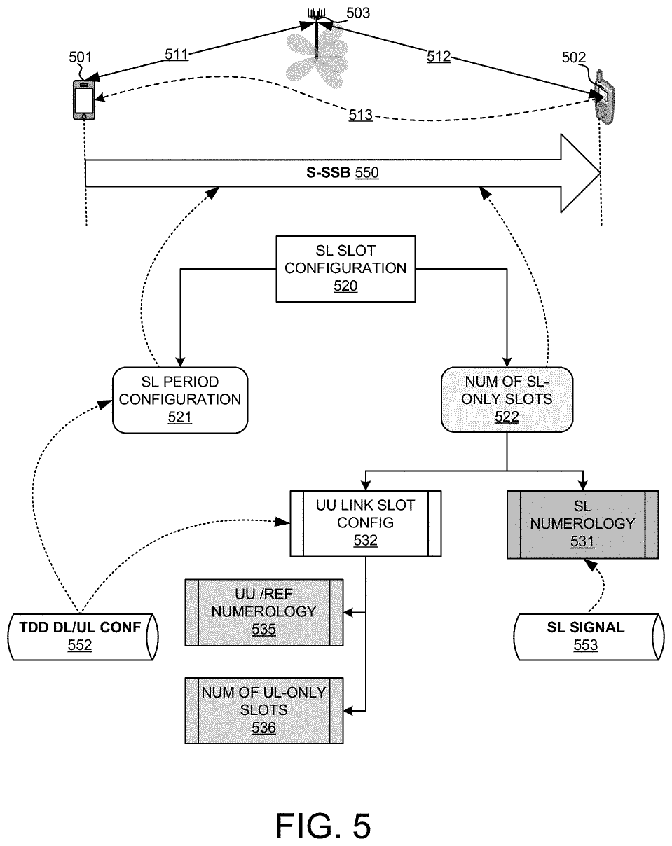

FIG. 5 illustrates exemplary diagrams for the sidelink slot configuration based on the reference numerology in accordance with embodiments of the current invention. A UE 501 and a UE 502 are connected in the NR network with a gNB 503 through Uu links 511 and 512, respectively. UE 501 and UE 502 are configured with sidelink configuration for sidelink 513. The UE determines sidelink slot configuration 520 based on reference pattern for slot configuration and the reference numerology. The SL slot configuration 520 configures a number of slots with only SL symbols and/or locations. The SL slot configuration 520 includes, among others, the SL periodicity configuration 521 and the number of SL slots configuration 522. The UE indicates configurations 521 and 522 in the sidelink synchronization signal block (S-SSB) 550. For TDD UL/DL information carried in S-SSB to determine the available SL slots, the indication for single period and dual-period patterns associated with the UL slots per period can be indicated in S-SSB derived from Uu interface (e.g., SIB messages). SL period configuration 521 including the periodicity configuration and pattern indication are obtained through TDD UL/DL configuration 552. In one embodiment, TDD UL/DL configuration 552 is carried in SIB messages.

Due to the limited bits in S-SSB, not all combinations can be carried. To save the bits, the patterns with the same period for each period in the dual-period, i.e., {P1=n, P2=n}, the same indication can be used with different granularity applied for different n value. For example, for dual-period patterns {P1, P2}={5,5}, the consecutive SL or UL slots for the pattern {5,5} is indicated by some bits. The other patterns with the same period in P1 and P2, i.e., {2,2}, {2.5,2.5} and {10,10}, refer to the indication of SL or UL slots for {5,5} pattern to derive the corresponding information and the numerology differences. As shown in diagram 430 and 440, when a reference pattern in diagram 430 is configured, the UE can derive the SL or UL slot configuration based on the reference pattern configuration in diagram 430.

Configuration in diagram 440, applies to sidelink and uplink slot configuration with different numerologies from the reference numerology μ_{ref}.

The number of sidelink slots only (SL-only) 522 can be derived from the Uu link slot configuration 532 and sidelink numerology 531. Uu link slot configuration 532 includes a Uu or reference numerology 535 and the number of UL or reference slots 536. The UL slots comprises a number of slots with UL-only symbols. In one embodiment, Uu link slot configuration 532 is obtained from the TDD UL/DL configuration 552. SL numerology can be (pre-)configured for the SL operation. In an embodiment, SL numerology 531 is obtained from SL signaling message 553, such as the RRC message. In yet another embodiment, for the inter-carrier indication of the TDD UL/DL configuration from eNB/gNB in a frequency to another frequency for SL operation, the numerology associated with TDD UL/DL configuration for SL frequency is indicated via base station signaling for SL operation, e.g., dedicated RRC or SIB messages for SL operation. According to an embodiment, the reference numerology is Uu link numerology. The Uu link numerology and the SL numerology can be (pre-)configured with the same or different numerologies.

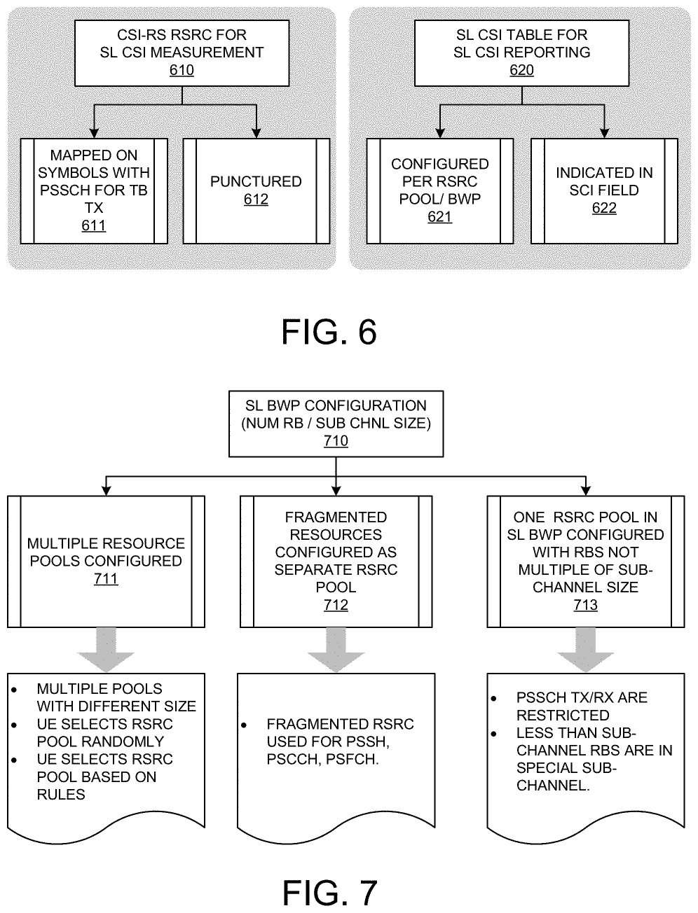

FIG. 6 illustrates exemplary diagrams for the sidelink CSI-RS resource allocation in accordance with embodiments of the current invention. In one embodiment, the CSI-RS for SL CSI measurement 610 is configured. In one embodiment 611, configuration 610 maps the resources on symbols with PSSCH for TB transmission. In another embodiment 612, punctured resources are used. The SL CSI-RS transmission for SL CSI measurement is rated matched according to the presence derived from SCI field (e.g., 2^{nd} stage SCI) for CSI request and the configuration of CSI-RS resources. Additionally, in one embodiment, CSI-RS resources are mapped on the PSSCH resources transmitting transport blocks (TBs). The CSI-RS resources cannot be mapped to PSSCH transmitting 2^{nd} stage SCI and/or PSSCH carrying 1^{st} stage SCI since the UE needs de-rate matching to decode the 1^{st} stage SCI and 2^{nd} stage SCI carrying CSI request field. Since the resource size for 2^{nd} stage SCI may vary, the exact CSI-RS resource location may vary as well to avoid collision among the 2^{nd} stage SCI and 1^{st} stage SCI resources. The CSI-RS resources can be only mapped on the symbols with PSSCH for TB transmission (i.e., without any 1^{st} stage SCI and 2^{nd} stage SCI transmission). In one embodiment, the exact CSI-RS resource location can be derived implicitly according to the time/frequency resources of 1^{st} stage SCI and/or 2^{nd} stage SCI or up to configuration. In another embodiment, SL CSI-RS resources can be punctured. It will be transparent to the UE receiver with minor or ignorable performance degradation.

In another embodiment, the SL CSI table for CSI reporting 620 is configured. In one embodiment 621, the SL CSI reporting resource is configured per resource pool/BWP. In another embodiment 622, the SL CSI reporting resource is indicated in SCI field. For SL CSI reporting, the assumed SL CSI table (e.g., 64QAM, 256QAM or ultra reliable low latency communication (URLLC) table) can be configured per resource pool/BWP and/or exchanged between UEs by PC5-RRC. Alternatively, the assumed SL CSI table can be indicated in SCI field (e.g., 2^{nd} stage SCI) from a set of (pre-) configured CSI tables. It enables the dynamic switching between SL MCS tables based on SL CSI reporting derived from the different assumed SL CSI tables corresponding to the different SL MCS tables. In one embodiment, only one assumed CSI table is indicated by SCI and/or higher layer signaling. The reported CSI is implicitly associated with such assumption. In another embodiment, multiple assumed CSI tables are indicated. The UE may report CSI associated with the assumed CSI table index, i.e., different CSI reports associated with the different CSI table. In case of multiple CSI resources are configured, the UE may report the CSI result associated with the corresponding CSI-RS resource index.

FIG. 7 illustrates exemplary diagrams for sidelink BWP configuration and allocation in accordance with embodiments of the current invention. In the NR network, the sub-channel is configured with N resource blocks (RBs). The SL BWP configuration 710 configures SL BWP with the number of RBs not the multiple of sub-channel size.

In one embodiment 711, one or multiple resource pools can be configured for fully utilizing all resources with the minimized fragmented resources (i.e., not multiple of or less than the sub-channel size). For example, the multiple resource pools can be configured with the different sub-channel size so that the fragmented resources will be quite limited. The UE may select the resource pool randomly or based on a rule (e.g., the priority levels for these resource pools).

In another embodiment 712, the fragmented resources can be configured as a separated resource pool which can be used for PSSCH and/or PSCCH and/or PSFCH transmission. Any number of PRBs can be configured for a resource pool.

In yet another embodiment 713, at most (or at least) one resource pool in SL BWP can be configured with the RBs not multiple of sub-channel size. For example, the multiple resource pools can be configured for a SL BWP with at most (or at least) one resource pools configured with RBs not the multiple of the sub-channel size. PSSCH transmission/reception will be restricted to the resources which are the multiple of sub-channel size. The lowest RB index of the lowest sub-channel index of the resource pool is the lowest RB index of the resource pool. The remaining RBs in the resource pool (i.e., less than the sub-channel size) can be specified as a special sub-channel, which can be used for PSSCH transmission but not PSCCH transmission, i.e., a kind of supplementary sub-channel for PSSCH transmission. Such special sub-channel can be used to carry PSCCH and PSSCH by FDMed multiplexing. In this case, PSCCH may be transmitted across all SL symbols in the SL slot except for GP symbols and PSFCH symbols if available.

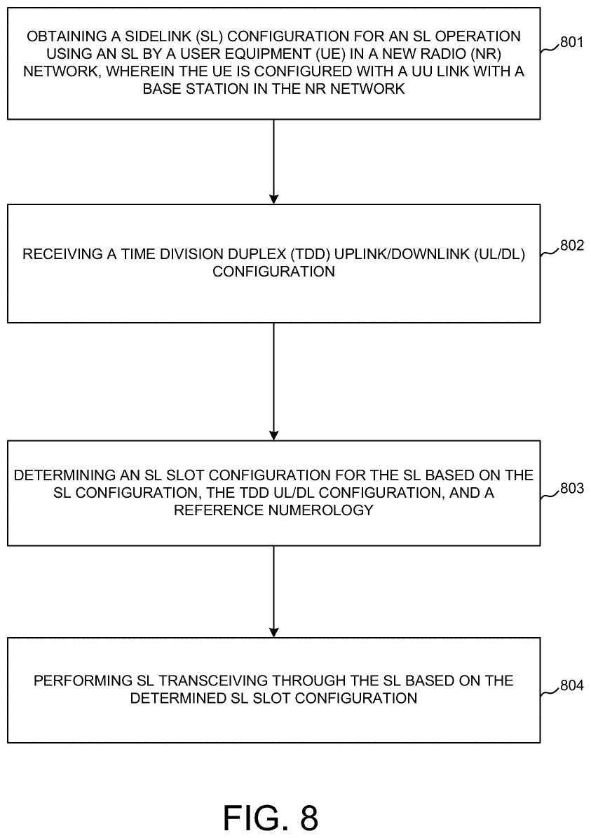

FIG. 8 illustrates an exemplary flow chart for the sidelink slot configuration procedure based on the reference numerology in accordance with embodiments of the current invention. At step 801, the UE obtains a sidelink (SL) (pre-)configuration for an SL operation using an SL in a wireless network, wherein the UE is configured with a Uu link with a base station in the wireless network. At step 802, the UE receives a TDD UL/DL configuration. At step 803, the UE determines an SL slot configuration for the SL based on the SL configuration, the TDD UL/DL configuration, and a reference numerology. At step 804, the UE performs SL transceiving through the SL based on the determined SL slot configuration. The SL configuration and/or UL configurations can be configured dynamically and preconfigured. When the UE obtains a configuration, the configuration can be preconfigured or configured.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
obtaining a sidelink (SL) configuration for an SL operation using an SL by a user equipment (UE) in a wireless network, wherein the UE is configured with a Uu link with a base station in the wireless network;
receiving a time division duplex (TDD) uplink/downlink (UL/DL) configuration;
determining an SL slot configuration for the SL based on the SL configuration, the TDD UL/DL configuration, and a reference numerology; and
performing SL transceiving through the SL based on the determined SL slot configuration.

2. The method of claim 1, wherein the SL slot configuration configures a number of slots with at least one element comprising SL-only symbols and SL-only locations.

3. The method of claim 2, wherein the number of slots with SL-only symbols is derived based a number of slots with UL-only symbols, the reference numerology and an SL numerology.

4. The method of claim 3, wherein the reference numerology is an Uu link numerology, and wherein the Uu link numerology and the SL numerology are different.

5. The method of claim 3, wherein the reference numerology is associated with the TDD UL/DL configuration.

6. The method of claim 3, wherein the SL numerology is pre-configured for the SL operation.

7. The method of claim 6, wherein the SL numerology is configured by receiving a signaling message selecting from a dedicated radio resource control (RRC) and a SIB message for the SL operation.

8. The method of claim 3, wherein the number of slots with UL-only symbols is derived from the TDD UL/DL configuration.

9. The method of claim 2, wherein the derived number of slots with SL-only symbols is carried in sidelink synchronization signal block (S-SSB).

10. The method of claim 1, the TDD UL/DL configuration is received in a system information block (SIB) from the base station.

11. A user equipment (UE), comprising:
a transceiver that transmits and receives radio frequency (RF) signal in a wireless network;
a sidelink (SL) configuration module that obtains an SL configuration for an SL operation using an SL in the NR network, wherein the UE is configured with a Uu link with a base station in the wireless network;
a synchronization module that receives a time division duplex (TDD) uplink/downlink (UL/DL) configuration;
an SL slot module that determines an SL slot configuration for the SL based on the SL configuration, the one or more synchronization configurations, and a reference numerology; and
an SL control module that performs SL transceiving through the SL based on the determined SL slot configuration.

12. The UE of claim 11, wherein the SL slot configuration configures a number of slots with at least one element comprising SL-only symbols and SL-only locations.

13. The UE of claim 12, wherein the number of slots with SL-only symbols is derived based a number of slots with UL-only symbols, the reference numerology, and an SL numerology.

14. The UE of claim 13, wherein the reference numerology is an Uu link numerology, and wherein the Uu link numerology and the SL numerology are different.

15. The UE of claim 13, wherein the reference numerology is associated with the TDD UL/DL configuration.

16. The UE of claim 14, wherein the SL numerology is pre-configured for the SL operation.

17. The UE of claim 16, wherein the SL numerology is configured by receiving a signaling message selecting from a dedicated radio resource control (RRC) and a SIB message for the SL operation.

18. The UE of claim 13, wherein the number of slots with UL-only symbols is derived from the TDD UL/DL configuration.

19. The UE of claim 12, wherein the derived number of slots with SL-only symbols is carried in sidelink synchronization signal block (S-SSB).

20. The UE of claim 11, the TDD UL/DL configuration is received in a system information block (SIB) from the base station.
